(19) United States
(12) Patent Application Publication
(10) Pub. No.: US 2010/0026800 A1
(43) Pub. Date: Feb. 4, 2010

(54) Club Cam Cruiser

(76) Inventors: Igor Kravets, Plano, TX (US); Jeffrey Dale Garza, Olathe, KS (US)

Correspondence Address: Jeffery D. Garza, 16037 S. Avalon St., Olathe, KS, 66062, US

(21) Appl. No.: 12/436,107

(22) Filed: May 5, 2009

Related U.S. Application Data
(60) Provisional application No. 61/050,900, filed on May 6, 2008.

(51) Int. Cl. H04N 7/18

(52) U.S. Cl. 348/135; 348/E07.085

(57) ABSTRACT

The invention allows video cameras in night clubs, so people can see the action from the Internet and pick which club to go to. It keeps club goers from wasting gas, driving from club to club only to find that they don't like the atmosphere.

Application claims benefits of Application No. 61/050,900, titled Club Cam Cruiser, filed May 6, 2008. This substitute Specification contains no new matter.

The present invention relates to Club Cam Cruiser. The invention, shown in FIG. 1, is comprised of an Internet camera shown in FIG. 2 of the drawing, linked to the website, and accessed with membership logins and monthly subscription fees as illustrated in FIG. 4 of the drawing.

The camera, Internet (by use of the Internet equipment shown in FIG. 3 of the drawing), and website links the whole product into clubcamcruiser.com as shown in FIG. 1.

### DRAWINGS DESCRIPTION

FIG. 1—The invention's overview.

FIG. 2—An example of a club's dance floor, showing an Internet camera.

FIG. 3—An example of the club's Internet equipment set up in a back office.

FIG. 4—An illustration of a club goer's PC (Personal Computer), logging in from any PC on the Internet.

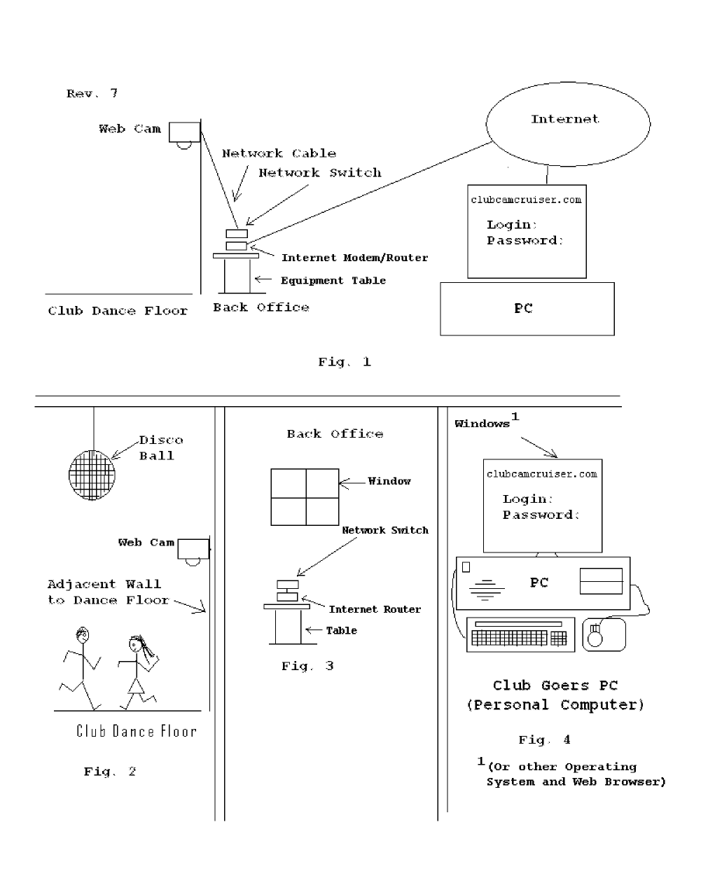

What is claimed is:

1. An internet camera feeds live video and audio to a subscription based website.

2. Club Owners and Managers will subscribe to the owner/manager's section of the subscription website and pay an installer to have the camera(s) installed and connected to a secure Internet connection, only viewable by the subscription based website.

3. Club Goers (the customers) will use the Club Goers section of the subscription based website to see and hear the club's overall scene's action to determine if they want to visit that club in person.

4. It will be wiser for the Club Goer to pay a monthly subscription fee to see and hear what club to visit, before wasting valuable resources in the form of time, money, cover charge fees, fuel, and transportation costs as described in claim #3.
